(19) United States
(12) Patent Application Publication
(10) Pub. No.: US 2011/0264662 A1
(43) Pub. Date: Oct. 27, 2011

(54) CONTEXT COLLECTION DEVICES, CONTEXT COLLECTION PROGRAMS, AND CONTEXT COLLECTION METHODS

(76) Inventor: Keisuke Umezu, Tokyo (JP)

(21) Appl. No.: 13/133,107

(22) PCT Filed: Dec. 21, 2009
(86) PCT No.: PCT/JP2009/071223

§ 371 Date: Jun. 6, 2011

(30) Foreign Application Priority Data
Jan. 5, 2009 (JP) 2009-000229

(51) Int. Cl. G06F 17/30

(52) U.S. Cl. 707/737; 707/736; 707/E17.089

(57) ABSTRACT

A content storage means stores content information that correlates available pieces of content with tags that are assigned thereto and that represent contexts in advance. A usage log storage means stores information that represents a piece of content that a user used as a usage log. A user context determination means obtains a tag that is assigned to a piece of content and that is contained in the usage log from the content information and determines a context of the user based on the obtained tag.

### TECHNICAL FIELD

The present invention relates to techniques that serve to collect contexts of content users.

### BACKGROUND ART

In recent years, systems that estimate contexts of users based on information obtained from various types of sensors and so forth and execute various types of information processes based on the contexts have been developed.

An exemplified context collection and utilization system of such a type is presented in Patent Literature 1, as identified below. The context collection and utilization system presented in Patent Literature 1 creates contexts from data and processes collected from a ubiquitous network and stores the contexts. In addition, the context collection and utilization system creates a view according to a request from a client based on the stored contexts.

The view in this case is significant to the client and therefore preferably satisfies its needs. This view can be used for various types of information processes in association with the needs of the client.

On the other hand, Patent Literature 2, as identified below, proposes a system that provides information content that follows and satisfies user's preference that changes as time passes. When the user selects information content, this system prompts him or her to input his or her mental information and updates attributes of the selected information content according to his or her mental situation that has been input. Thus, since the attributes of information content are dynamically updated as user's preference changes, the provided information content hardly deviates from the user's preference.

Patent Literature 3, as identified below, presents a technique that searches for products that are recommended to a user when he or she uses a particular product. In this technique, “product information” that identifies products is correlated in advance with “characteristic word groups” each of which is composed of at least one word that characterizes a product. When the user used a particular product, a word correlated with the product is obtained and products that are recommended to the user are searched for with the key of the word.

In addition, Patent Literature 3 presents a technique that obtains words correlated with those contained in “the characteristic word group” assigned to the product from “product characteristic word storage section” so as to increase the number of words as search keys in “a characteristic word group” assigned to products.

Patent Literature 4, as indicated below, presents a technique that collects element information that represents contexts based on a user's operation. In addition, Patent Literature 4 presents a technique that updates the value of a context (status) through learning based on the history of collected contexts. In this technique, time series information composed of elements such as statuses is divided into time series information groups according to a predetermined continuity rule and then a learning process is performed for each time series information group as one learning object. This learning process allows status values and action values of individual statuses from the beginning to the end of the time series information groups to be updated.

### RELATED ART LITERATURES

### Patent Literatures

Patent Literature 1: JP 2005-128836A, Publication

Patent Literature 2: JP 2004-70510 A, Publication

Patent Literature 3: JP 2008-225584 A, Publication

Patent Literature 4: JP 2005-267483 A, Publication

### SUMMARY OF THE INVENTION

### Problems to be Solved by the Invention

There are various types of user's contexts, for example, those perceived as objective facts such as the current position, age, occupation, and sex of the user. They also include those perceived as user's internal emotions such as preference, feeling, want, and what the user is going to do. They further include those perceived as user's actions such as dining, moving, and working. Moreover, they can be contemplated to include those that may affect a user's context such as current weather, temperature, congestion, and presence/absence of the user's partner although they are not his or her context.

Among these contexts, those that represent “a user's current status” such as a user's feeling, presence/absence of partner, action, want, and thing-to-do are referred to as fragile contexts.

Fragile contexts are those that exactly represent a user's current context and are useful for performing various types of information processes for the user. Fragile contexts, however, tend to change in a relatively short period and may be difficult to measure by sensors and so forth as objective facts. Thus, at present, there is no technique that can properly collect a user's fragile context.

For example, the techniques presented in Patent Literatures 1, 2, and 4 basically cause a user to manually input his or her context. However, it is quite bothersome and impractical to make the user input his or her context every time his or her context changes. For example, it would be impossible to make the user input various types of contexts such as current action, partner, and emotion as they change.

On the other hand, although Patent Literature 3 presents the technique that correlates products with words characterizing them in advance and estimates products that are recommended based on a word corresponding to a product that the user used, words are collected so as to determine products that are recommended, not to obtain a user's context.

As described above, any of the above-presented techniques cannot properly collect users' contexts.

An object of the present invention is to properly collect a user's context.

Means that Solve the Problem

To accomplish the foregoing object, a context collection device according to the present invention, comprises:
content storage means that stores content information that correlates available pieces of content with tags that are assigned thereto and that represent contexts in advance;
usage log storage means that stores information that represents a piece of content that a user used as a usage log; and
user context determination means that obtains a tag that is assigned to a piece of content and that is contained in said usage log from said content information and determines a context of said user based on the obtained tag.

A context collection program according to the present invention causes a computer to execute procedures, comprising:
a content storage procedure that stores content information that correlates available pieces of content with tags that are assigned thereto and that represent contexts in advance;
a usage log storage procedure that stores information that represents a piece of content that a user used as a usage log; and
a user context determination procedure that obtains a tag that is assigned to a piece of content and that is contained in said usage log from said content information and determines a context of said user based on the obtained tag.

A context collection method according to the present invention, comprises:
storing content information that correlates available pieces of content with tags that are assigned thereto and that represent contexts in advance;
storing information that represents a piece of content that a user used as a usage log;
obtaining a tag that is assigned to a piece of content and that is contained in said usage log from said content information; and
determining a context of said user based on the obtained tag.

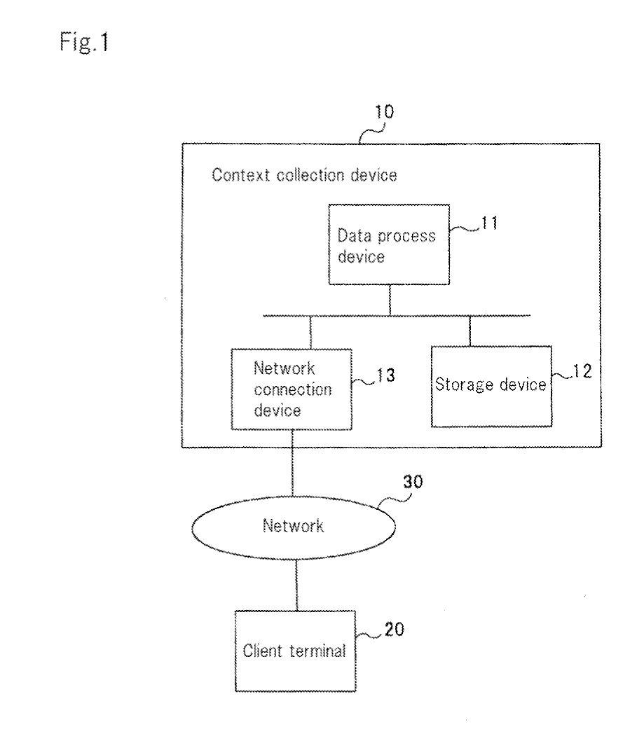

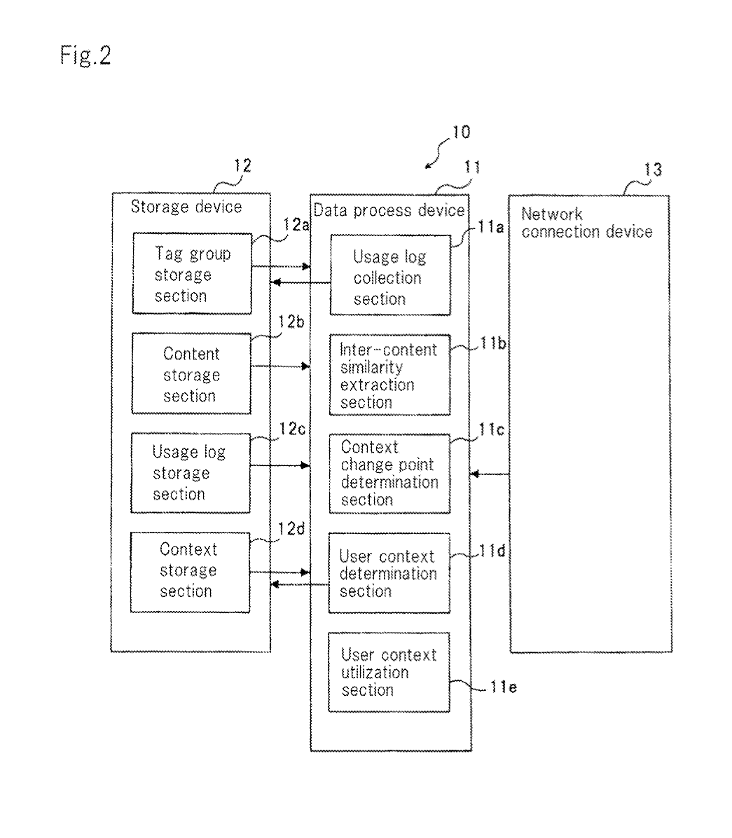

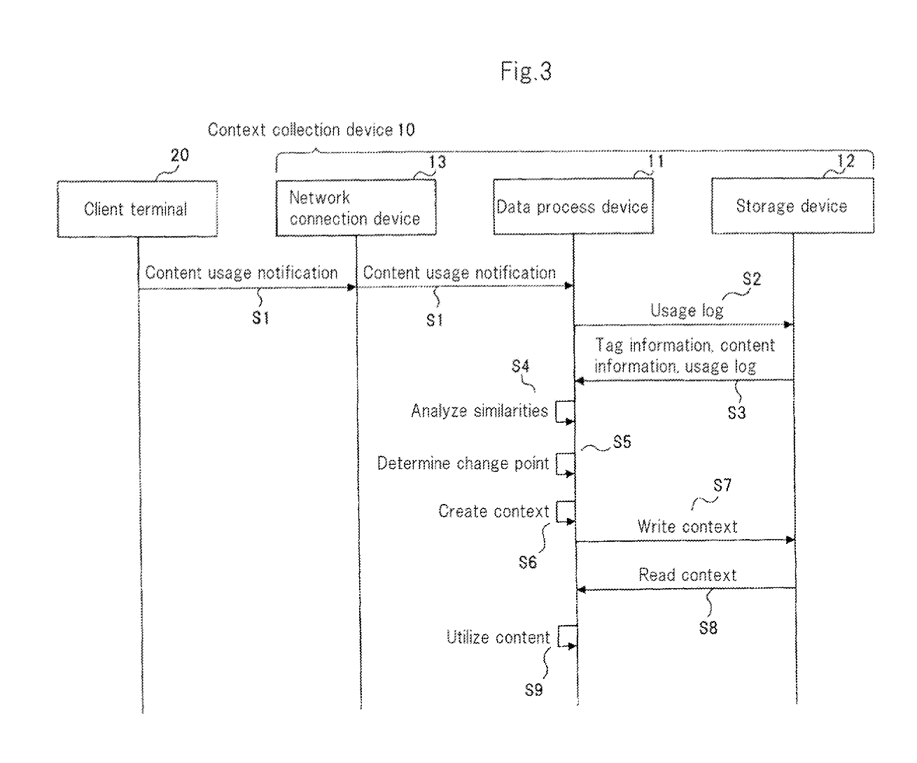

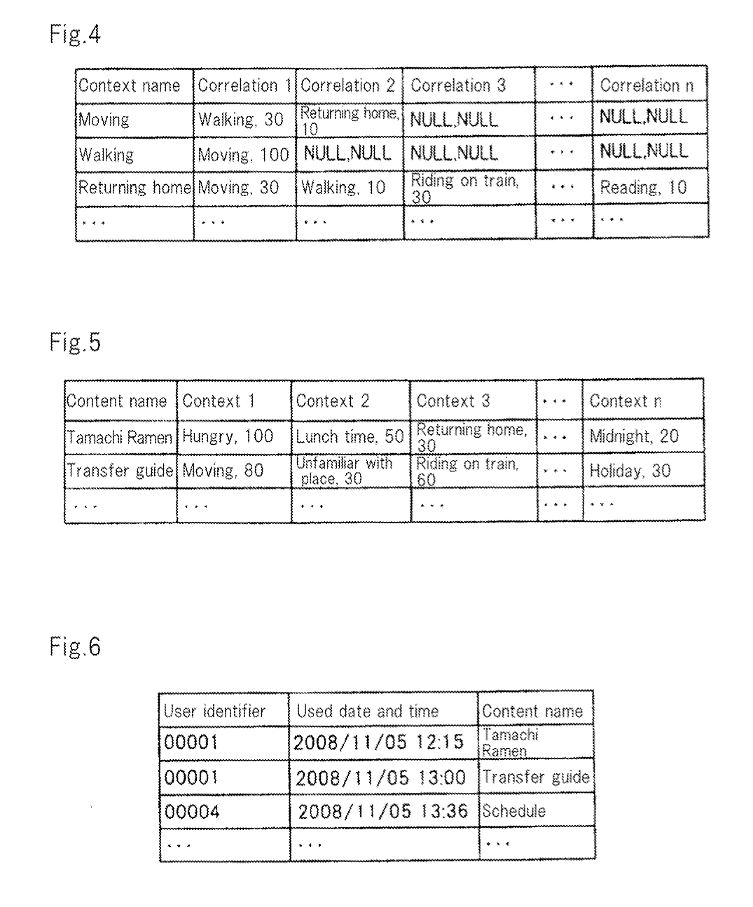

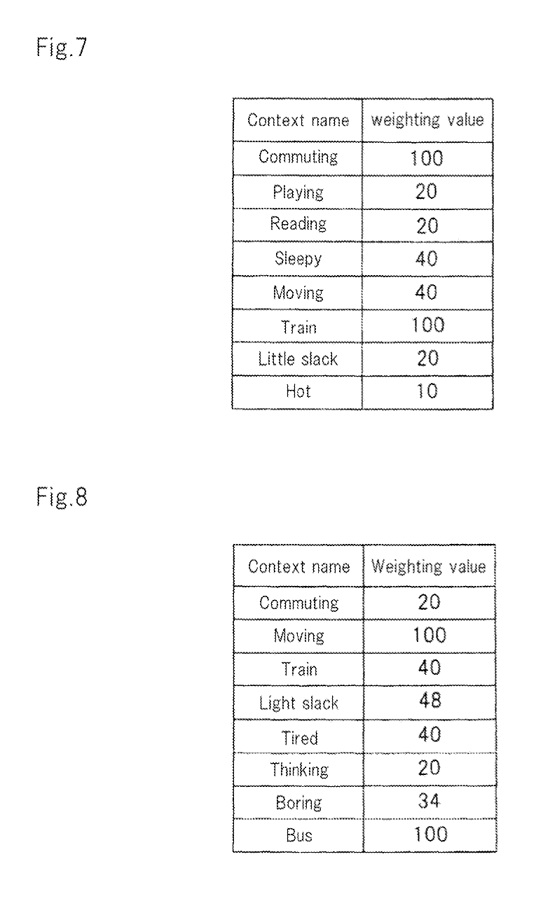

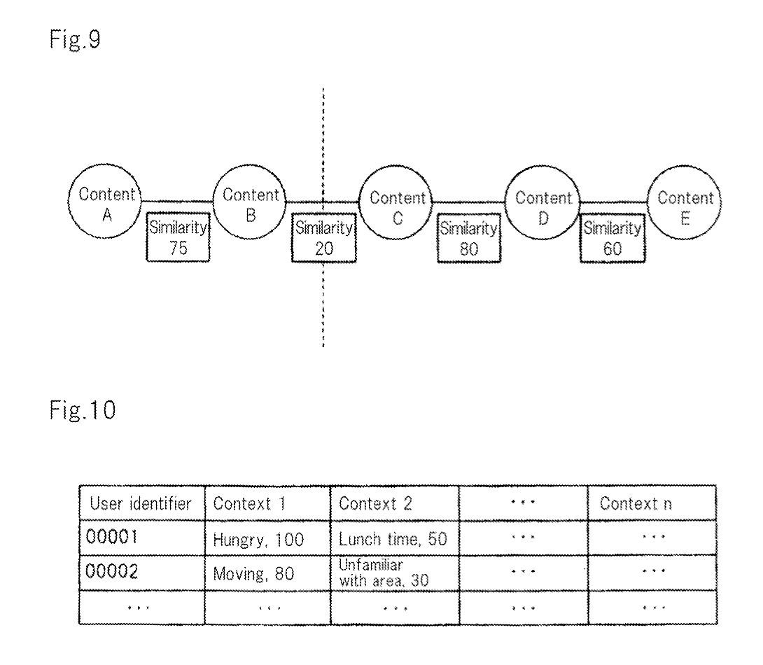

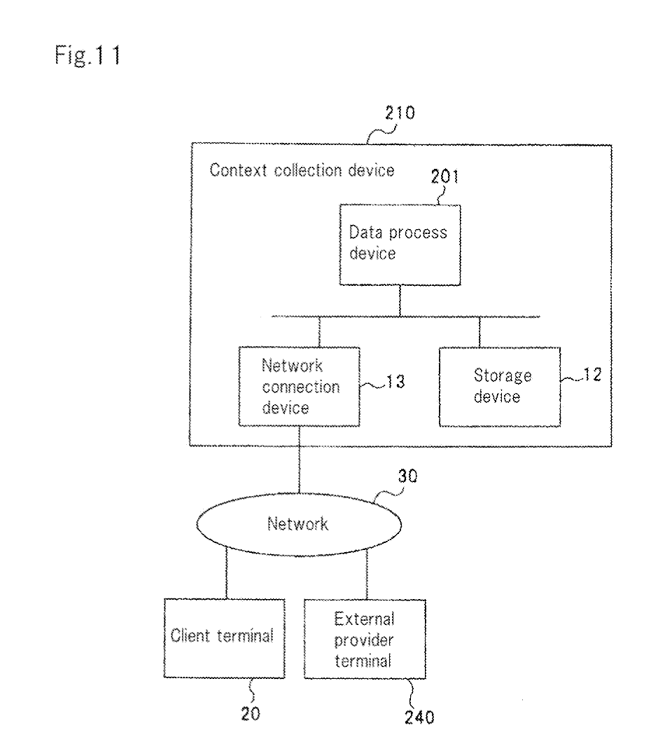

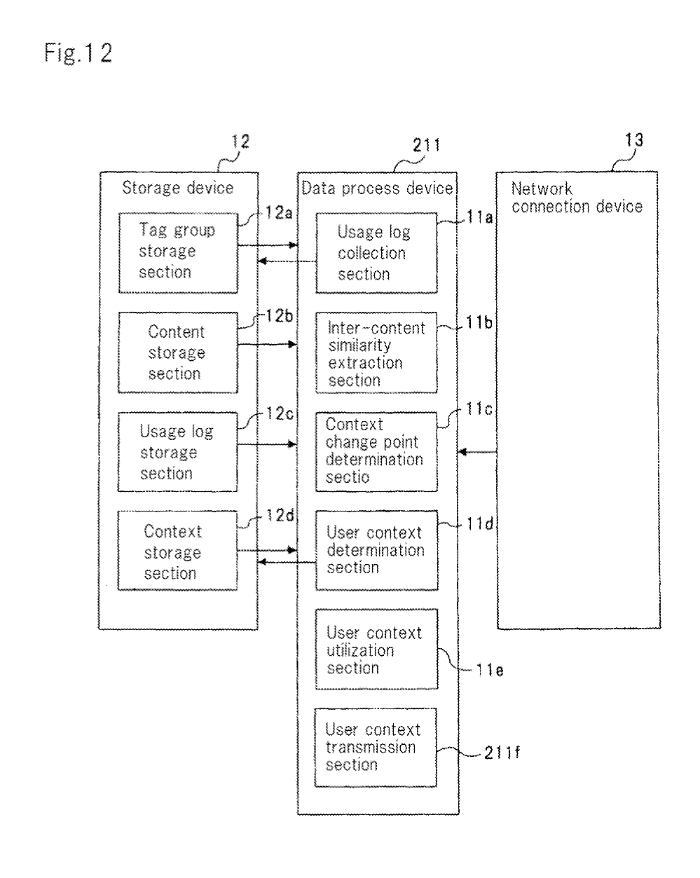

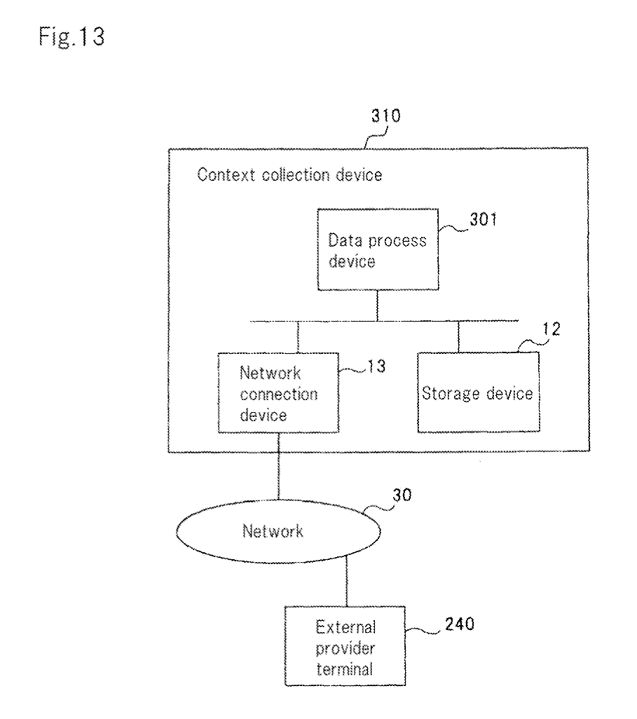

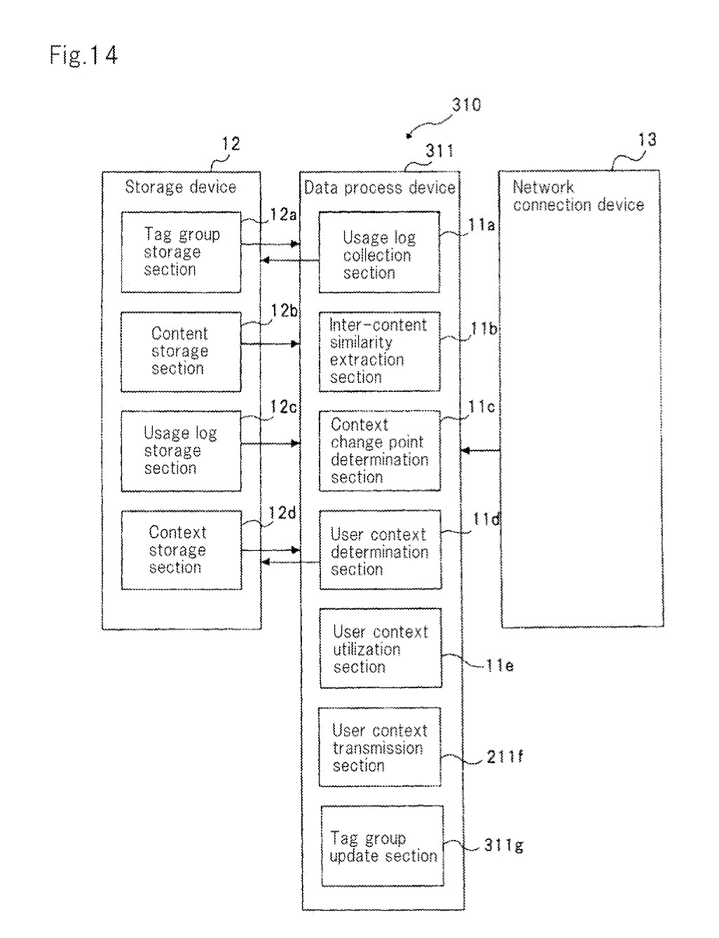

### BRIEF DESCRIPTION OF DRAWINGS

[FIG. 1] is a block diagram showing a structure of a context collection system according to a first embodiment.

[FIG. 2] is a block diagram showing a structure of a context collection device according to the first embodiment.

[FIG. 3] is a flow chart showing an operation of the context collection system.

[FIG. 4] is a chart showing an example of the substance of correlation information stored in advance in tag group storage section 12a.

[FIG. 5] is a chart showing an example of the substance of correlation information stored in advance in content storage section 12b.

[FIG. 6] is a chart showing exemplified usage logs stored in usage log storage section 12c.

[FIG. 7] is a chart showing an extension tag list of content A.

[FIG. 8] is a chart showing an extension tag list of content B.

[FIG. 9] is a chart showing an exemplified context change point in a content sequence arranged in a time series order.

[FIG. 10] is a chart showing exemplified users' contexts.

[FIG. 11] is a block diagram showing a structure of a context collection system according to a second embodiment.

[FIG. 12] is a block diagram showing a structure of a context collection device according to the second embodiment.

[FIG. 13] is a block diagram showing a structure of a context collection system according to a third embodiment.

[FIG. 14] is a block diagram showing a structure of a context collection device according to the third embodiment.

### BEST MODES THAT CARRY OUT THE INVENTION

With reference to drawings, embodiments of the present invention will be described.

### First Embodiment

FIG. 1 is a block diagram showing a structure of a context collection system according to a first embodiment. FIG. 2 is a block diagram showing a structure of a context collection device according to the first embodiment. Referring to FIG. 2, context collection device 10 has data process device 11, storage device 12, and network connection device 13.

Referring to FIG. 1, context collection device 10 obtains a usage log of content used on client terminal 20 from network 30 through network connection device 13. Then, context collection device 10 stores the obtained usage log to storage device 12.

When new data are stored in storage device 12, data process device 11 reads the content usage log, tag information assigned to the content, and content definition information from storage device 12, analyzes a user's context, and creates a latest context as the analyzed result. The created context is stored in storage device 12.

Moreover, data process device 11 reads the user's context from storage device 12 and utilizes the contexts so as to execute various types of information processing to provide services to the user.

Network 30 can be a network of any type as long as it allows context collection device 10 and client terminal 20 to communicate information with each other.

Client terminal 20 is a communication device such as a mobile phone, a PHS (Personal Handy-phone System), a PDA (Personal Digital Assistant), or a PC (Personal Computer) and is a device on which the user operates to use content. Client terminal 20 according to this embodiment may be a device of any type as long as it can communicate with context collection device 10. For example, client terminal 20 may be an IC (Integrated Circuit) tag that can perform short range communication.

Next, context collection device 10 will be described.

Referring to FIG. 2, storage device 12 is provided with tag group storage section 12a, content storage section 12b, usage log storage section 12c, and context storage section 12d. Data process device 11 is provided with usage log collection section 11a, inter-content similarity extraction section 11b, context change point determination section 11c, user context determination section 11d, and user context utilization section 11e.

Tag group storage section 12a stores tags that represent contexts and correlation information that represents correlations of tags as sets of links and degrees of correlations. In this example, it is assumed that links are unidirectional links. Although tags themselves represent contexts, they are information that can be used to analyze a context.

Content storage section 12b stores content information that correlates pieces of contents with tags assigned thereto.

Usage log storage section 12c stores information about content collected by usage log collection section 11a and used on client terminal 20 as a usage log.

Context storage section 12d stores the user's context created by user context determination section 11d.

Usage log collection section 11a obtains information about content that the user used from client terminal 20 and stores the obtained information as a usage log to usage log storage section 12c.

Inter-content similarity extraction section 11b arranges information about content that is contained in the usage log stored in usage log storage section 12c and that the user used in the time series order. In addition, inter-content similarity extraction section 11b extends information about a tag assigned to each piece of content based on correlation information stored in tag group storage section 12a. Moreover, inter-content similarity extraction section 11b computes the similarities of pieces of content that are adjacent in the time series order.

Context change point determination section 11c determines a context change point that represents a time point at which a user's context changed based on the similarities computed by inter-content similarity extraction section 11b.

User context determination section 11d analyzes the user's context based on the context change point obtained by context change point determination section 11c and tags assigned to pieces of content after the context change point and creates a latest user's context as an analyzed result. The context that user context determination section 11d created is stored in context storage section 12d.

User context utilization section 11e executes various types of information processing for services to the user based on the context as the substance stored in context storage section 12d.

Next, an operation of the context collection system according to this embodiment will be described in detail. FIG. 3 is a flow chart showing the operation of context collection system.

FIG. 4 is a chart showing an example of the substance of correlation information stored in advance in tag group storage section 12a. Referring to FIG. 4, the correlation information contains sets each of which is composed of a correlated tag of each tag that represents a context and the degree of correlation that represents the intensity of correlation with each tag in a list format. A tag and its correlated tags are unidirectional linked. For example, context “moving” is a concept that includes context “walking.” Such correlations of contexts are defined as correlation information.

Definitions of correlations of contexts are useful to remove ambiguities of fragile contexts. Assuming a scene in which the user is walking from his or her nearby station to his or her home, contexts “moving,” “returning home,” “walking,” and so forth can be contemplated as those that represent his or her actions in this scene. All these three contexts are suitable as those that represent the actions of the user and thereby only one context cannot be selected from them. Many fragile contexts may be those that have ambiguities.

If correlations of contexts with ambiguities are not defined, context “moving” and context “walking” may be determined as those having completely different meanings. As a result, it becomes difficult to effectively use collected contexts.

When correlations of contexts are defined, if context “walking” is clear as the context of a particular user, an estimation in which context “moving” may be applied as the context of the user can be made. By repeating such an estimation, as many contexts can be obtained as possible from a small number of contexts.

Likewise, it is useful to define correlations of contexts having similar meanings such as context “walking” and context “moving.” When correlations of contexts with similar meanings have been defined, search misses that occur in searching for content based on a user's context can be decreased.

For example, when context “moving” is defined, context “walking” and context “returning home” that have meanings similar thereto can be correlated with context “moving.”

Correlations can be defined by two values “context name, degree of correlation.” Next, another method of defining a degree of correlation will be exemplified. In this example, it is assumed that as a degree of correlation, a value in the range from 0 to 100 is assigned and 100 represents the highest degree of correlation. For example, if a correlation is assigned to the relationship of “when the user is walking, he or she is always moving,” “moving, 100” can be stored as an element of correlation α of a row of context name “walking.”

FIG. 5 is a chart showing an example of the substance of content information stored in advance in content storage section 12b. Content storage section 12b stores correlations of the pieces of content and at least one tag assigned thereto in a list format. Correlations are represented by sets each of which is composed of a tag name and a degree of importance. These tags need to be present in tag information stored in tag group storage section 12a. These tags are preferably assigned to the pieces of content in consideration of a user's context. Data may be written to tag information by a person who supervises context collection device 10 or a content provider.

Alternatively, by statistically analyzing the value of a context of a user when he or she used content, a context assigned to the content and the degree of importance may be decided, corrected, or updated. Thus, a context can be created from that state in which no context has been assigned to the content or a user's context can be exactly determined.

Referring to FIG. 3, usage log collection section 11a provided in data process device 11 receives a notification about the usage of content from client terminal 30 through network connection device 13 (at step S1) and then stores it as a usage log to usage log storage section 12c (at step S2).

FIG. 6 is a chart showing exemplified usage logs stored in usage log storage section 12c. Referring to FIG. 6, a usage log is composed of a set of three pieces of information that are user identifier, used date and time, and used content. Usage logs are stored in a list format. Thus, from usage logs, the relationship of each user, content that he or she used, and date and time on/at which he or she used the content can be obtained.

Thereafter, inter-content similarity extraction section 11b obtains tag information stored in tag group storage section 12a, content information stored in content storage section 12b, and usage logs stored in usage log storage section 12c (at step S3). Thereafter, inter-content similarity extraction section 11b extracts a list of the pieces of content that a particular user used based on the usage logs.

Thereafter, inter-content similarity extraction section 11b extracts a context assigned to each of the extracted contexts from content information stored in content storage section 12b and extends contexts based on tag information stored in tag group storage section 12a. When the contexts are extended, the number of tags increases.

In addition, inter-content similarity extraction section I lb creates an extended tag list based on the degree of importance and degree of correlation of each tag. The extended tag list is list of information that is stored in a list format of sets each of which is composed of an extended tag (context) and a weighting value.

Moreover, inter-content similarity extraction section 11b arranges used pieces of content in the time series order and computes the similarities of adjacent pieces of content. The similarities are computed by comparing tags assigned to adjacent two pieces of content (at step S4).

Next, an exemplified method of computing the similarities of pieces of content will be described. In this example, the similarities of content A and content B are computed.

First, an extended tag list assigned to each piece of content is created based on the substance stored in content storage section 12b and tag group storage section 12a. FIG. 7 is a chart showing an extended tag list of content A. FIG. 8 is a chart showing an extended tag list of content B.

For example, an extended tag list can be created according to the following method.

It is assumed that “moving, 100” as a set of a tag name and a degree of importance has been designated to content A. At this point, with reference to the substance of tag group storage section 12a, a set of a link of a correlated context of context “moving” and the degree of correlation of the link is read. If the data that have been read contain “walking, 40,” the data denote that when context “moving” has been confirmed, the probability of which the context “walking” is “40%.”

In this case, tag “walking” is added to the extended tag list and the degree of importance of tag “walking” is designated “degree of importance of extension source tag×degree of correlation/100=100×0.4=40.” This computation is performed for all tags correlated with context “moving.” If the obtained degree of importance is lower than a given threshold (in this example, “10”), the tag is not added to the extended tag list. This means that if the degree of importance is lower than the threshold, it is determined that the context is not useful.

In addition, the tag extension process is also performed for a tag that has been newly added to the extended tag list. At this point, if a tag that is to be added is already present in the extended tag list, the obtained degree of importance is added to the degree of importance in the extended tag list. However, the upper limit of the degree of importance is 100.

By changing the threshold, the extension range of a context can be adjusted. For example, if the threshold is decreased (for example, “1”), since the number of contexts that are determined to be useful increases, the range of contexts that are extended widens. In contrast, if the threshold is increased (for example, “20”), the range of contexts that are extended narrows. When the range of contexts that are extended is narrowed, since the amount of computation necessary to extract an extended tag list becomes small, the process of estimating a context can be performed in a short time.

After extended tag lists for content A and content B have been created, the degrees of importance of tags contained in each extended tag list are summed up. Thereafter, the sum of the degrees of importance of tags contained in content A and the sum of the degrees of importance contained in content B are averaged. In this example, the sum of the degrees of importance of tags contained in content A shown in FIG. 7 is “350”, whereas the sum of the degrees of importance of tags contained in content B shown in FIG. 8 is “402.” Thus, the average of these sums is “376.”

Thereafter, by comparing the two extended tag lists, tags (contexts) contained in both the extended tag lists are extracted. In this example, four tags “commuting,” “moving,” “train,” and “little slack” are extracted. Thereafter, the degrees of importance for each of the tags extracted from the two extended tag lists are compared and the lower value of each of the tags is designated as a similarity point. Last, the sum of the similarity points is divided by the average of the degrees of importance. The computed result becomes the degree of similarity of contexts. In this example, since the sum of similarity points is “120” (=20+40+40+20), 120/376≈0.32 is the degree of similarity of content A and content B.

The computed degree of similarity of pieces of content is supplied to context change point determination section 11c. Context change point determination section 11c determines a timing at which a context changes in the content sequence arranged in the time series order based on the degree of similarity of adjacent pieces of content.

Since “a fragile context” tends to change and thereby a user's context likely disappears, it is useful to obtain a change point of a context and consider it when the context is analyzed. For example, context “riding on train” disappears when the user gets off the train. When such a context changes, if content that the user used before such a change occurs is used to analyze a context, the latest, correct context cannot be extracted. Thus, it is preferred that the latest user's context be decided based on content that the user used after a change point.

Next, an exemplified method in which context change point determination section 11c determines a context change point will be described.

Context change point determination section 11c computes the average of the degrees of similarity of all pieces of content that have been supplied and designates the computed average as a threshold. Thereafter, context change point determination section 11c clusters pieces of content that have a degree of similarity equal to or greater than the designated threshold and obtains the average of the degrees of similarity in each cluster. Thereafter, context change point determination section 11c creates two virtual contexts that have the degree of similarity of the obtained average and substitutes them for a pair of pieces of content that have not been clustered. Thereafter, context change point determination section 11c obtains the average of the degrees of similarity of all pieces of content, designates the obtained average as a threshold, and treats a point between pieces of content that have a degrees of similarity equal to or lower than the threshold as a context change point (at step S5).

FIG. 9 is a chart showing an exemplified context change point in a content sequence arranged in the time series order. In the example shown in FIG. 9, contents A to E are arranged in the time series order and there is a context change point between content B and content C.

User context determination section 11d creates a user's context based on the context change point obtained by context change point determination section 11c and contexts assigned to pieces of content after the last context change point (at step S6).

As a method of creating a user's context, user context determination section 11d sums up the degrees of importance of contexts assigned to pieces of content after the last context change point for each context. Thereafter, user context determination section 11d computes the average of the sums of each context, designates the computed average as a threshold, and treats contexts that have a sum equal to or greater than the threshold as user's contexts.

User context determination section 11d writes the created user's contexts to context storage section 12d (at step S7). FIG. 10 is a chart showing exemplified users' contexts. Referring to FIG. 10, contexts of a user having user identification 00001 are “hungry” and “lunch time.” Context storage section 12d also stores degrees of importance of individual contexts of users.

User context utilization section 11e obtains users' contexts as the substance of context storage section 12d (at step S8) and executes various types of information processes for services to particular users based on their contexts (at step S9). The services are not limited as long as they use users' contexts. As an example of the services, an advertisement delivery system that delivers advertisements to users based on their contexts can be contemplated. In addition, an SNS (Social Network Service) and an application delivery service that use users' contexts may be contemplated.

As described above, according to this embodiment, fragile contexts are assigned as tags to pieces of content that users can use in advance and then tags assigned to pieces of content that users used are collected and analyzed. Thus, fragile contexts of users can be easily and adequately collected.

In addition, according to this embodiment, a context change point of a user is determined based on the degrees of similarity of pieces of content and a latest context of the user is created based on information about pieces of content used after the latest context change point. Thus, a user's context can be decided with effective data only after his or her context has been changed, but without noise data that occurred before his or her context changed. Next, this method will be described in detail.

Generally, when analyzing “a context that easily changes (for example, getting on a train, etc)” that may change for example in around 10 minutes, it is not reasonable to use a tag that was obtained one hour before. Thus, usage history that can be used to analyze “a context that easily changes” is limited to tags that have been recently obtained in a short period and there is unlikely to be a sufficient number of tags that can be effectively used to estimate a context.

In addition, when analyzing “a context that easily changes,” incorrect contexts tend to be frequently extracted. This means that a piece of content to which contexts that changed had been assigned is used to analyze a context. For example, now assume a scene in which restaurant content is searched for in several restaurants at lunch time and news and stock information contents are used after the lunch. In the case of the foregoing technique that automatically extracts a user's context, if several pieces of restaurant content are used, context “hungry” is extracted. After the meal, while the user is using news and stock information contents, an emotion (context) “hungry” must have disappeared. However, since the context is analyzed using the usage history of restaurant content, context “hungry” remains.

The technique presented in the foregoing Patent Literature 4 determines the continuity of contexts in the time series order based on a continuity rule. However, it is necessary to designate a continuity rule in advance. In addition, to adequately determine the continuity, it is necessary to properly designate a rule consisting of a plurality of items as shown in FIG. 10. Thus, it is not easy to accomplish this technique.

In contrast, according to this embodiment, since a context change point of a user is determined based on the degrees of similarity of pieces of content and since pieces of content of the usage logs are divided, a user's context can be adequately and easily decided based on data in a proper range of the usage logs.

In addition, according to this embodiment, correlations of tags (contexts) are stored in advance and tags are extended based on the correlations so as to analyze a user's context. Thus, even if the number of tags that are obtained is small, a user's context can be adequately analyzed. In addition, correlative tags can be adequately extracted from pieces of content that were used and contexts can be adequately analyzed without the necessity of assigning a lot of tags to pieces of content. When contexts with similar meanings are defined in advance, search misses that occur in searching for pieces of content that match a user's context can be decreased.

### Second Embodiment

FIG. 11 is a block diagram showing a structure of a context collection system according to a second embodiment. As shown in FIG. 11, the context collection system according to the second embodiment is different from the context collection system according to the first embodiment shown in FIG. 1 in that the former includes external provider terminal 240.

External provider terminal 240 obtains a user's context from context collection device 210 through network 30 and uses the obtained user's context for an information process. Various applications can be contemplated for the information process based on a user's context.

External provider terminal 240 may be a device of any type as long as it can communicate with context collection device 210 and execute a process based on a user's context created by context collection device 210. Examples of external provider terminal 240 are an advertisement delivery provider terminal, an application delivery service provider terminal, and a content usage tread research provider terminal.

FIG. 12 is a block diagram showing a structure of the context collection device according to the second embodiment. As shown in. FIG. 12, context collection device 210 according to the second embodiment is different from context collection device 10 according to the first embodiment in that data process device 211 of the former includes user context transmission section 211f.

User context determination section 11d creates a user's context and stores it to context storage section 12d. User context transmission section 211f transmits the user's context stored in context storage section 12d to external provider terminal 240 according to a query therefrom. When external provider terminal 240 obtains the user's context from context collection device 210 through network 30, external provider terminal 240 performs various types of information processing based on the context.

In addition, usage log collection section 11a according to this embodiment may be provided with a function that collects a usage log from external provider terminal 240 through network 30 in addition to the function of usage log collection section 11a according to the first embodiment. In this case, it is assumed that sets of pieces of content with which external provider terminal 240 deals and tags assigned thereto have been stored in usage log storage section 12c. Moreover, it is assumed that the tags have been also stored in tag group storage section 12a.

When external provider terminal 240 determines that a user uses content, external provider terminal 240 transmits a set of the user's identification, the date and time on and at which he or she used the content, and the name of the content to usage log collection section 11a through network 30. Usage log collection section 11a stores the received information as a usage log to usage log storage section 12c. However, at that point, usage log collection section 11a can decide whether or not to store the received information in usage log storage section 11a.

As described above, according to this embodiment, since external provider terminal 240 is notified of a user's context that context collection device 210 created, the user's context can be shared by a plurality of devices. As a result, the load for the process imposed on each provider can be eliminated in comparison with the case in which each provider creates the user's content.

In addition, according to this embodiment, since context collection device 210 can collect usage logs from external provider terminal 240, a user's context can be created based on the usage logs obtained by a plurality of providers. As a result, since the amount of data that can be used to create a user's context is increased, a user's fragile context can be appropriately collected.

### Third Embodiment

FIG. 13 is a block diagram showing a structure of a context collection system according to a third embodiment. As shown in FIG. 13, the context collection system according to the third embodiment is different from the first embodiment in that the former includes external provider terminal 240, but does not include client terminal 20. External provider terminal 240 according to this embodiment is the same as the external provider terminal 240 according to the second embodiment. In addition, context collection device 310 according to this embodiment is a client terminal such as a mobile phone, a PHS, a PDF, or a PC. Thus, FIG. 13 does not show other client terminals.

External provider terminal 240 obtains a user's context from context collection device 210 through network 30 and uses the obtained user's context for an information process. Various applications can be contemplated for the information processing based on a user's context.

External provider terminal 240 may be a device of any type as long as it can communicate with context collection device 210 and execute a process based on a user's context created by context collection device 210. Examples of external provider terminal 240 are an advertisement delivery provider terminal, an application delivery service provider terminal, and a content usage tread research provider terminal.

FIG. 14 is a block diagram showing a structure of the context collection device according to the third embodiment. As shown in FIG. 14, context collection device 310 according to the third embodiment is different from context collection device 10 according to the first embodiment in that data process device 311 of the former includes user context transmission section 211f and tag group update section 331g. However, user context transmission section 211f is the same as that according to the second embodiment.

User context determination section 11d creates a user's context and stores it in context storage section 12d. User context transmission section 211f transmits the user's context stored in context storage section 12d to external provider terminal 240 according to a query therefrom. When external provider terminal 240 obtains the user's context from context collection device 310 through network 30, external provider terminal 240 performs various types of information processing based on the context. At that point, user context transmission section 211f provided in context collection device 310 built in the client terminal can select whether or not to transmit the user's context to external provider terminal 240 according to a command issued from the user.

In addition, according to this embodiment, usage log collection section 11a stores information of a set of content delivered from external provider terminal 240 to the user and a context assigned to the content as a usage log in usage log storage section 12c.

Thus, it is assumed that sets of pieces of content with which external provider terminal 240 deals and tags assigned thereto are defined as tag information in advance in tag group storage section 12a. Usage log collection section 1b provided in external provider terminal 240 selects a piece of content delivered to the user from those defined in tag group storage section 12a and notifies context collection device 310 of the selected one.

Tag group update section 311g statistically analyzes usage logs stored in context storage section 12d so as to update correction information that represents correlations of tags, stored in tag group storage section 12a. For example, an action pattern that a user will likely take may be estimated based on usage logs so as to increase the correction of a link of tags that match the action pattern. If an action pattern that a user reads, while he or she is returning home, is estimated based on usage logs, the correlation of a link from the tag “returning home” to a tag “reading” may be increased.

As described above, according to this embodiment, since the client terminal of each user stores a user's context created by context collection device 310 and since each user can determine whether or not to transmit the user's context to external provider terminal 240, the privacy of each user can be satisfactorily protected.

In addition, according to this embodiment, like the second embodiment, since context collection device 310 can collect usage logs from external provider terminal 240, a user's context can be created based on the usage logs obtained by a plurality of providers. As a result, since the amount of data that can be used to create a user's context is increased, a user's fragile context can be appropriately collected.

Although the foregoing first to third embodiments disclose systems that determine that determine a context change point in a usage log, divide a usage log at the context change point, and thereby analyze or create a user's context, the present invention is not limited thereto.

As another example of the present invention, when a user uses content, his or her context may be analyzed based on a tag assigned to the content. As a specific example, such a context analysis device may store context information that correlates available pieces of content with tags that are assigned thereto and that represent contexts in advance. In addition, the context analysis device may store information representing substances of content that the user used as usage logs, obtain tags assigned thereto from the content information, and analyze a user's context based on the obtained tags.

As a further example of the present invention, when a user used content, a user's context may be analyzed based on a tag assigned to the content and other tags correlated with the assigned tag. As a specific example, such a context analysis device may store content information that correlate available substances of content with tags that are assigned thereto and that represent contexts and correlation information that represents correlations of tags in advance. The context analysis device stores information that represents pieces of content that the user used as usage logs, obtains tags assigned thereto from the usage logs, obtains correlated tags from correlation information, and analyzes a user's context based on both types of tags.

The context collection devices according to the foregoing embodiments can also be accomplished by causing a computer to execute a software program that defines a procedure of each section that composes a data process device.

The foregoing embodiments should be construed so as to easily understand the present invention, not limit it. The present invention may be changed and modified without departing from the spirit thereof and include its equivalents.

### INDUSTRIAL APPLICABILITY

The present invention may be used for a mobile advertisement delivery system that estimates emotion, action, environment situation of each user based on a user's context and recommends or delivers appropriate advertisements to each user.

As another example, the present invention may be used for an application delivery system that estimates emotion, action, environment situation of a user based on his or her context and recommends or delivers appropriate applications to each user.

As a further example, the present invention may be used for a mobile phone-oriented advertisement delivery system that estimates emotion, action, environment situation of a user based on his or her context and recommends or delivers appropriate information to each user.

As a further another example, the present invention may be used for a device control system that estimates emotion, action, environment situation of a user based on his or her context and controls a device appropriately with his or her emotion. As a specific example, the present invention may be a system that automatically adjusts the temperature of air conditioning when the user feels hot or cold.

Now, with reference to the embodiments, the present invention has been described. However, it should be understood by those skilled in the art that the structure and details of the present invention may be changed in various manners without departing from the scope of the present invention.

The present application claims a priority based on Japanese Patent Application JP 2009-000229 filed on Jan. 5, 2009, the entire contents of which are incorporated herein by reference in its entirety.

1-16. (canceled)

17. A context collection device, comprising:
a content storage section that stores content information that correlates available pieces of content with tags that are assigned thereto and that represent contexts in advance;
a usage log storage section that stores information that represents a piece of content that a user used as a usage log; and
a user context determination section that obtains a tag that is assigned to a piece of content and that is contained in said usage log from said content information and determines a context of said user based on the obtained tag.

18. The context collection device as set forth in claim 17, further comprising:
an inter-content similarity extraction section that extracts similarities of adjacent pieces of content arranged in a time series order from said usage log; and
a context change point determination section that determines a context change point that represents a time point at which the context of said user changed based on said similarities,
wherein said user context determination section divides said usage log at said context change point so as to analyze the content of said user.

19. The context collection device as set forth in claim 18,
wherein said user context determination section decides a latest context of said user based on contexts after a latest context change point, the contexts being assigned to said pieces of content contained in said usage log.

20. The context collection device as set forth in claim 19, further comprising:
a context utilization section that executes an information processing for said user based on the latest context decided by said user context determination section.

21. The context collection device as set forth in claim 19, further comprising:
a user context transmission section that notifies an information process device that executes the information processing for said user based on the context of the latest context decided by said user context determination section.

22. The context collection device as set forth in claim 17, further comprising:
a tag group storage section that stores correlation information that represents is correlations of tags stored in said content storage section,
wherein said user context determination section obtains a tag assigned to said piece of content contained in said usage log from said correlation information, obtains correlated tags of said assigned tag from said correlation information, and uses said assigned tag obtained from said context information and said correlated tags obtained form said correlation information so as to determine a context of said user.

23. The context collection device as set forth in claim 21,
wherein said correlations are represented by a link between tags, and
wherein said user context determination section obtains a tag linked from said assigned tag obtained from said context information from said correlation information.

24. The context collection device as set forth in claim 17,
wherein said context collection device is built in a client terminal on which said user uses content.

25. The context collection device as set forth in claim 17, further comprising:
a usage log collection section that detects said user used content and stores information about the content as said usage log in said user log storage section.

26. The context collection device as set forth in claim 17,
wherein said context includes at least one of type of information that represent an action, an emotion, a feeling, and a partner of said user.

27. A non transitory computer-readable medium containing a context collection program that causes a computer to execute procedures, comprising:
a content storage procedure that stores content information that con⁻elates available pieces of content with tags that are assigned thereto and that represent contexts in advance;
a usage log storage procedure that stores information that represents a piece of content that a user used as a usage log; and
a user context determination procedure that obtains a tag that is assigned to a piece of content and that is contained in said usage log from said content information and determines a context of said user based on the obtained tag.

28. The non transitory computer-readable medium as set forth in claim 27, wherein the context collection program further causes the computer to execute:
an inter-content similarity extraction procedure that extracts similarities of adjacent pieces of content arranged in a time series order from said usage log; and
a context change point determination procedure that determines a context change point that represents a time point at which the context of said user changed based on said similarities,
wherein said user context determination procedure divides said usage log at said context change point so as to analyze the content of said user.

29. The non transitory computer-readable medium as set forth in claim 27, wherein the context collection program further causes the computer to execute:
a tag group storage procedure that stores correlation information that represents correlations of tags stored by said content storage procedure,
wherein said user context determination procedure obtains a tag assigned to said piece of content contained in said usage log from said correlation information, obtains correlated tags of said assigned tag from said correlation information, and uses said assigned tag obtained from said context information and said correlated tags obtained form said correlation information so as to determine a context of said user.

30. A context collection method, comprising:
storing content information that correlates available pieces of content with tags that are assigned thereto and that represent contexts in advance;
storing information that represents a piece of content that a user used as a usage log;
obtaining a tag that is assigned to a piece of content and that is contained in said usage log from said content information; and
determining a context of said user based on the obtained tag.

31. The context collection method as set forth in claim 30, further comprising:
extracting similarities of adjacent pieces of content arranged in a time series order from said usage log;
determining a context change point that represents a time point at which the context of said user changed based on said similarities; and
dividing said usage log at said context change point so as to analyze the content of said user.

32. The context collection method as set forth in claim 30, further comprising:
storing correlation information that represents correlations of tags contained in content information; and
obtaining a tag assigned to said piece of content contained in said usage log from said correlation information, obtaining correlated tags of said assigned tag from said correlation information, and using said assigned tag obtained from said context information and said correlated tags obtained form said correlation information so as to determine a context of said user.
